(19) United States
(12) Patent Application Publication
(10) Pub. No.: US 2017/0339244 A1
(43) Pub. Date: Nov. 23, 2017

(54) MEDIA DEVICE AND METHOD FOR SETTING A CONFIGURATION OF THE SAME

(71) Applicant: HUMAX CO., LTD., Yongin (KR)

(72) Inventor: Jeong Kyu KIM, Gimhae (KR)

(21) Appl. No.: 15/478,642

(22) Filed: Apr. 4, 2017

(30) Foreign Application Priority Data
May 17, 2016 (KR) 10-2016-0060360

(51) Int. Cl. H04L 29/08; H04L 12/24; G08C 17/02

(52) U.S. Cl. CPC H04L 67/306; H04L 41/0813; H04L 41/0806; H04L 67/1095; H04L 67/16; G08C 2201/21; G08C 17/02; H04L 67/18

(57) ABSTRACT

A media device and a method for setting a configuration of the same are disclosed. The media device comprises a communication unit connected to a portable terminal, and configured to receive setting information from the portable terminal. The setting information includes at least a portion of internal information of the portable terminal. The media device includes a configuration unit configured to set an initial setting of a configuration by using the received setting information. Here, the configuration unit sets a user account as one of the initial setting according to the received setting information, and the set user account is matched with personalized information or a personalized service provided for a user after the initial setting is completed.

### PRIORITY

This application claims priority under 35 U.S.C. 119(a) to a Korean patent application filed on May 17, 2016 in the Korean Intellectual Property Office and assigned Serial No. 10-2016-0060360, the entire disclosure of which is incorporated herein by reference.

### BACKGROUND

### 1. Field of the Invention

The present disclosure relates to a media device and a method for setting a configuration of the same.

### 2. Description of the Related Art

A remote controller is generally used as an input device for controlling a set-top box. A user can conveniently control a channel or an audio with the remote controller, but it is inconvenient for the user to input texts in order to select a function of the set-top box or set a specific configuration of the set-top box.

The set-top box should set many settings of its configuration when it is initially installed. In this case, it is restrained to set the settings via an input of the remote controller.

### SUMMARY

The invention has been made to address at least the disadvantages and problems described above, and to provide at least the advantage described below. An aspect of the invention provides a media device for automatically setting its configuration using internal information of a portable terminal, and a method for setting a configuration of the same.

Another aspect of the invention is to provide a media device capable of enhancing user's convenience by minimizing user's input when setting the configuration of the media device, and a method for setting a configuration of the same.

According to one embodiment of the invention, a media device comprises: a communication unit connected to a portable terminal, and configured to receive setting information from the portable terminal, the setting information including at least a portion of internal information of the portable terminal; and a configuration unit configured to set an initial setting of a configuration by using the received setting information. Here, the configuration unit sets a user account as one of the initial setting according to the received setting information, and the set user account is matched with personalized information or a personalized service provided for the user after the initial setting is completed.

According to another embodiment of the invention, a media device comprises: a communication unit configured to receive setting information from a plurality of terminals; and a configuration unit configured to set an initial setting of a configuration by using common information or collection information of the received setting information.

According to still another embodiment of the invention, a user terminal comprises: a communication unit; a memory configured to store at least one application and internal information; and a processor configured to execute the application. Here, the application executed by the processor obtains internal information to be used for setting the initial setting of a configuration of a media device as setting information, and transmits the obtained setting information to the media device when the user terminal is connected to the media device. A portion of the setting information is information related to a setting of a user account of the media device.

According to still another embodiment of the invention, a method for setting a configuration of a media device comprises: obtaining setting information to be used for setting the configuration of the media device of internal information of a portable terminal from the portable terminal according as the portable terminal is connected to the media device; and setting at least a portion of an initial setting of the configuration of the media device using the obtained setting information. Here, a user account is set as one of the initial setting of the configuration according to the obtained setting information, and the set user account is matched with personalized information or a personalized service provided for the user after the initial setting of the configuration is completed.

According to still another embodiment of the invention, a set-top box comprises: a communication unit connected to a portable terminal, and configured to receive setting information, the setting information including at least a portion of internal information of the portable terminal from the portable terminal; and a configuration unit configured to set an initial setting of a configuration by using the received setting information. Here, the initial setting includes one or more of a language setting, a nation setting, a time setting or an account setting.

A media device and a method for setting a configuration of the same according to the invention may automatically set the configuration of the media device by using internal information of a portable terminal.

Accordingly, a user's input may be minimized when setting the configuration of the media device, and thus user's convenience may be enhanced.

### BRIEF DESCRIPTION OF DRAWINGS

The aspects, features, advantages and embodiments of the invention will be more apparent from the following detailed description taken in conjunction with reference to the accompanying drawings, in which:

FIG. 1 is a view schematically illustrating a system for setting a configuration of a media device according to a first embodiment of the invention;

FIG. 2 is a flowchart illustrating a method for setting the configuration of the media device according to a first embodiment of the invention;

FIG. 3 is a view illustrating a method for setting configuration of a media device in a multi-room environment according to a second embodiment of the invention;

FIG. 4 is a flowchart illustrating a method for setting a configuration of a media device when portable terminals access one media device according to a third embodiment of the invention;

FIG. 5 is a flow chart illustrating a method for renewing the configuration of the media device according to a fourth embodiment of the invention;

FIG. 6 is a block diagram schematically illustrating constitution of a portable terminal according to a first embodiment of the invention; and

FIG. 7 is a view schematically illustrating constitution of the media device according to a first embodiment of the invention.

### DETAILED DESCRIPTION

Various embodiments of the present invention are disclosed herein. Specific structural and functional details disclosed in the embodiments are presented for purposes of explanation and illustration, but are not intended to be exhaustive or limited to the embodiments disclosed. The embodiments were chosen and described in order to best explain the principles of the invention and its practical applications, to thereby enable others skilled in the art to best utilize the invention and to understand the embodiments with various modifications.

It will be understood that, although the terms first, second, etc. may be used herein to describe various elements, these elements should not be limited by these terms. These terms are only used to distinguish one element from another.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The invention sets, changes or renews at least a portion of a configuration of a media device including a set-top box by using the portion of internal information of a portable terminal. As a result, the invention may enhance user's convenience by minimizing an input of setting information for the configuration of the media device via a remote controller. Hereinafter, the embodiments of the invention will be described in detail with reference to accompanying drawings.

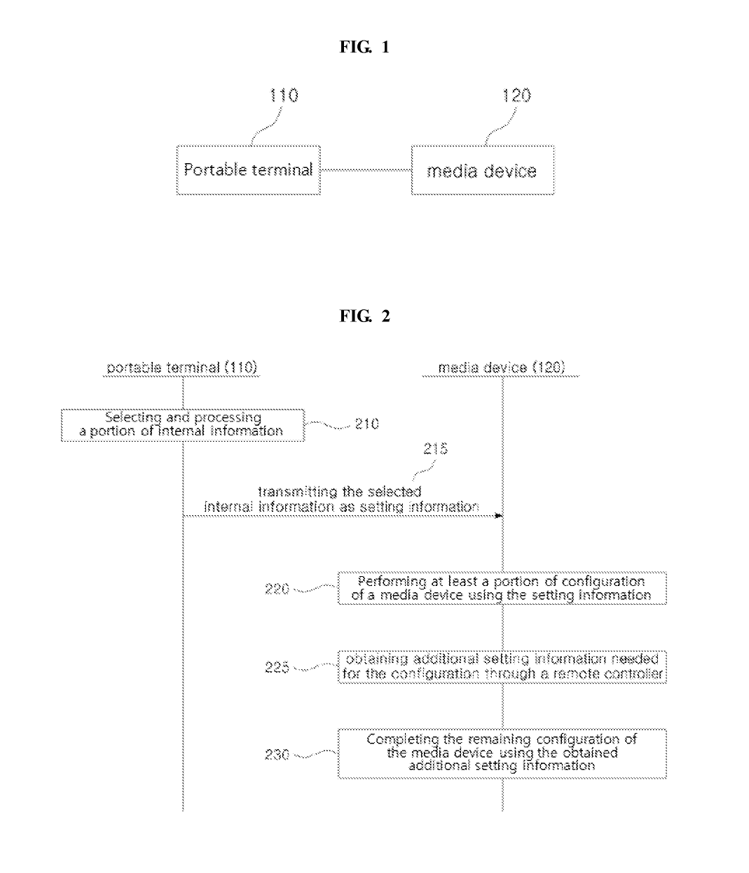

FIG. 1 is a view schematically illustrating a system for setting a configuration of a media device according to a first embodiment of the invention.

In FIG. 1, the system of the present embodiment includes a portable terminal 110 and a media device 120.

The portable terminal 110 includes, but not limited to, an electronic device such as a mobile communication terminal and a tablet PC. From user's perspective, the portable terminal 110 can be called as a user terminal because the user uses it. Of course, the user terminal is not limited to the portable terminal 110.

The portable terminal 110 may select/select and process at least a portion of internal information of the portable terminal 110 when it is connected to the media device 120 and transmit the selected/selected and processed information as setting information to the media device 120. Here, the setting information may include at least one of nation information, local area information, time information, language information or user's account information to social media like a YouTube.

An application for selecting at least a portion of the internal information as the setting information needed for setting the configuration of the media device 120 and transmitting the setting information may be installed in the portable terminal 110, which is not shown in FIG. 1. Furthermore, the portable terminal 110 may transmit the portion of the internal information as the setting information to the media device 120 via corresponding application.

The portable terminal 110 may install the application by tagging a tag adhered to the media device 120. Further, the portable terminal 110 may receive access information for installing the application from the media device 120 when it initially accesses the media device 120 and install the application using the received access information. Of course, the portable terminal 110 may download the application through an app store, etc. in the portable terminal 110 and install the downloaded application.

Hereinafter, it is assumed that the portable terminal 110 transmits the setting information through the application while the application is being executed in the portable terminal 110.

The media device 120 is a means for providing various services including real time program or video on demand VOD. The media device 120 includes a broadcasting device such as a set-top box (STB) or a television in which the set-top box is embedded. The media device 120 may be a device for playing back the real time broadcasting program, the VOD, etc. That is, the media device 200 is not limited to a specific device as long as it can playback a media.

The media device 120 may obtain at least a portion of the internal information as the setting information from the portable terminal 110 as the media device 120 is connected to the portable terminal 110 by wire or wirelessly. Then, the media device 120 may set, change or renew at least a portion of the configuration of the media device 120 based on the obtained internal information.

It is understood that the setting of the configuration of the media device 120 includes setting the configuration of the media device 120 according to a different feature in nations or local areas in which the media device 120 is initially installed, and changing at least a portion of the configuration of the media device 120 under the condition that basic configuration of the media device 120 is set or renewing at least a portion of the configuration of the media device 120 according to a function upgrade of the media device 120.

Hereinafter, a method for setting the configuration of the media device 120 when the media device 120 is linked to the portable terminal 110 will be described in detail.

FIG. 2 is a flowchart illustrating a method for setting the configuration of the media device according to a first embodiment of the invention.

In a step of 210, the portable terminal 110 may extract at least a portion of its internal information and process the extracted internal information.

For example, the portable terminal 110 may extract at least a portion of its internal information from an USIM or an internal memory, and convert a format of the extracted internal information into a format suitable for the media device 120.

Here, the internal information may be one or more of nation information or local area information based on the USIM of the portable terminal 110, time information set in the portable terminal 110, user's account information stored in the portable terminal 110, a user's phone number, a user name and a serial number of the portable terminal 110.

The portable terminal 110 may extract its internal information needed for setting the configuration of the media device 120 through an application executed therein and process the extracted internal information.

In a step of 215, the portable terminal 110 transmits the internal information as the setting information to the media device 120 as the portable terminal 110 is connected to the media device 120.

Here, the portable terminal 110 may transmit the setting information to the media device 120 when the connection to the media device 120 is completed or in the process of setting a communication channel trying the connection to the media device 120.

In the event that the portable terminal 110 transmits the setting information to the media device 120 under the condition that the connection to the media device 120 is not completed (i.e., in the process of setting the communication channel), the portable terminal 110 may encrypt the setting information and transmit the encrypted setting information to the media device 120. In the event that authentication of the portable terminal 110 is completed after the process of setting the communication channel between the media device 120 and the portable terminal 110 is completed, the media device 120 may decrypt the encrypted setting information and use the decrypted setting information. The encryption may include various methods such as a method using public key/private key, a compression method based on terminal information (for example, phone number) of the portable terminal 110, etc.

The portable terminal 110 and the media device 120 may be connected through a short range wireless communication or a mobile communication.

For convenience of description, it is assumed that the portable terminal 110 and the media device 120 are connected through a Bluetooth pairing in the description.

Accordingly, the portable terminal 110 may transmit at least a portion of the internal information as the setting information to the media device 120 when the portable terminal 110 is connected to the media device 120 through the Bluetooth pairing.

In a step of 220, the media device 120 sets at least a portion of the configuration of the media device 120 by using the setting information received from the portable terminal 110.

In a step of 225, the media device 120 obtains additional setting information needed for the configuration via a remote controller.

In a step of 230, the media device 120 completes the remaining configuration of the media device 120 by using the obtained additional setting information.

The steps 225 to 230 may be further performed or may not be performed. That is, the steps 225 to 230 may not be performed in the event that the process of setting the configuration of the media device 120 is completed by using at least a portion of the internal information of the portable terminal 110.

Since the media device 120 sets at least a portion of the configuration of the media device 120 by using the internal information of the portable terminal 110, a process of obtaining information for setting the configuration using the remote controller may be minimized, thereby enabling a user to set conveniently the configuration.

Since the user sets at least a portion of the configuration of the media device 120 based on the internal information of his portable terminal 110, the user may automatically and adaptively set the configuration of the media device 120, which varies depending on the nation or the local area, corresponding to a feature of a respective nation based on nation information among the internal information of the portable terminal 110, and thus the user's convenience may be enhanced.

In another embodiment, the internal information differs according to location information of the portable terminal 110 (i.e., location information of the user carrying portable terminal 110). The internal information may be transmitted to the media device 120 and the configuration of the media device 120 may be set according to the transmitted internal information. For example, Korean language may be set as a basic language of the media device 120 when the user is in Korea, and English may be set as the basic language of the media device 120 when the user is in the US. In this case, the configuration of the media device 120 may vary according to the location of the user even if the user uses one portable terminal 110. This setting of the configuration may be practically useful.

On the other hand, the configuration of the media device 120 may be changed or be further set by using the internal information of the portable terminal 110 after the media device 120 completes the initial setting of the configuration without using the portable terminal 110. However, a setting item in the configuration (e.g., language, etc.) which is not frequently changed may be set at the initial setting of the configuration of the media device 120. A setting item in the configuration which is frequently changed in accordance with user's selection may be further set by user's request after the initial setting of the configuration of the media device 120.

Limitation on the user in setting the configuration of the media device 120 using the portable terminal 110 is not mentioned in above description. However, the user who can change the configuration of the media device 120 or the media device 120 whose configuration can be changed by a certain user may be designated. In this case, no one or a media device except for the designated user or the media device 120 can change the configuration of the media device 120. Of course, this designation may be changed by a primary user of the media device 120.

For example, the first portable terminal 110 transmitting the setting information for the initial setting of the configuration of the media device 120 may be determined as a master terminal. In this case, other terminals except for the master terminal cannot change the initial setting of the configuration once the initial setting of the configuration is set by the master terminal. The initial setting of the configuration may be changed by other terminals only when the master terminal allows them to change the initial setting of the configuration. Of course, any setting in the configuration except the initial setting may be set by other terminals, not the master terminal. On the other hand, various methods of determining the master terminal may exist apart from the above method for determining the first portable terminal 110 transmitting the setting information for the initial setting of the configuration as the master terminal. For example, the user may designate any terminal as the master terminal. That is, the method for determining the master terminal is not limited to the method described above.

Hereinafter, other embodiments for setting the configuration of the media device will be described in detail.

In a first embodiment, in the event that the media device 120 is a broadcasting device, the media device 120 may receive user information related directly to the user as well as general information such as language information, nation information or time information, etc. as the setting information from the portable terminal 110. The media device 120 may set an initial setting related to the general information and an initial setting related to the user information according to the setting information. For example, the initial setting related to the general information may be a setting about language, nation or time, etc., and the initial setting related to the user information may be a setting about a user account of the media device 120 and so on.

That is, in the event that the portable terminal 110 transmits the language information, the nation information, the time information or information concerning a user phone number (or a user name, a serial number, etc.) to the media device 120, the media device 120 may generate a user account based on the user phone number, etc. while setting the language, the nation or the time, etc. as the initial setting. Here, the user account means an account in the media device 120 programmed to be matched with personalized information or service including contents recommendation, viewing constraint, a favorite program, a personalized menu, a recording or an SNS, etc. A user account as the internal information in the portable terminal 110 indicates an account (ID, password and so on) of a website, etc. which the user uses through the portable terminal 110.

In a second embodiment, in the event that other portable terminals are connected to the media device 120 after the media device 120 sets the initial setting (including generation of the user account) of the configuration according to the setting information received from a specific portable terminal, the media device 120 may generate user accounts corresponding to the other portable terminals without changing the initial setting of the configuration according to information received from the other portable terminals after the connection. That is, the initial setting may be performed by the portable terminal firstly connected or a master terminal, and the user accounts may be generated with respect to portable terminals connected later. Of course, the other portable terminals may additionally set or change a setting other than the initial setting.

For another example, multiple portable terminals may be connected to the media device 120. The media device 120 may set the initial setting of the configuration by using setting information of a specific portable terminal and generate user accounts for all connected portable terminals.

In a third embodiment, the portable terminal 110 may obtain user profile information by analyzing records of the user's access to website, the user's image viewing, or the user's access to favorite programs, etc. The portable terminal 110 may transmit the setting information including the obtained user profile information and the information such as the language information and the nation information to the media device 120. In this case, the media device 120 sets the initial setting of the configuration according to the setting information, wherein it may set a setting related to the user profile information. For example, the media device 120 may set the setting of the configuration related to program recommendation, viewing constraint, generation of favorite channel list, etc. according to the user profile information.

In a fourth embodiment, the media device 120 may request to the portable terminal 110 information about specific items (for example, language, nation, phone number, time, social media account) as the setting information. The portable terminal 110 may internally search the specific items according to the request of the media device 120. In this case, a part of the specific items (e.g., language, nation, phone number, time) may be searched, and the remaining part of the specific items (e.g., social media account) may not be searched. The portable terminal 110 transmits the searched items as the setting information to the media device 120. The item (e.g., social media account) which is not searched may be transmitted from an external device like a cloud server to the media device 120 according to a request of the portable terminal 110 or the media device 120. As a result, the media device 120 may obtain information about every specific item (the language, the nation, the phone number, the time, the social media account) by collecting the information received from the portable terminal 110 and the information received from the external device. The media device 120 may set the initial setting of the configuration by using the received information (e.g., the language, the nation, the phone number, the time, the social media account).

That is, the media device 120 may set the initial setting of the configuration by using the setting information received from the portable terminal 110 and information received from other terminals. Of course, the media device 120 may set the initial setting of the configuration by using only the setting information received from the portable terminal 110 without using the information received from the external device.

In the above description, the media device 120 may select specific items and request to the portable terminal 110 for the setting information about the specific items. However, the media device 120 may merely transmit the request for the setting information to the portable terminal 110, and an application in the portable terminal 110 may extract the specific items from the portable terminal 110.

In a fifth embodiment, the media device 120 may set the initial setting of the configuration by using the setting information received from the portable terminal 110, encrypt the setting information so that the setting information is not exposed to outside, and then store the encrypted setting information. Here, the setting information may be stored in the media device 120 or in an external cloud server, etc.

In a sixth embodiment, the setting information related to the portable terminal 110 is not transmitted from the portable terminal 110 to the media device 120. The setting information may be transmitted from other devices having information concerning the portable terminal 110 (another device possessed by the user of the portable terminal 110, a cloud server having user information, etc.) to the media device 120.

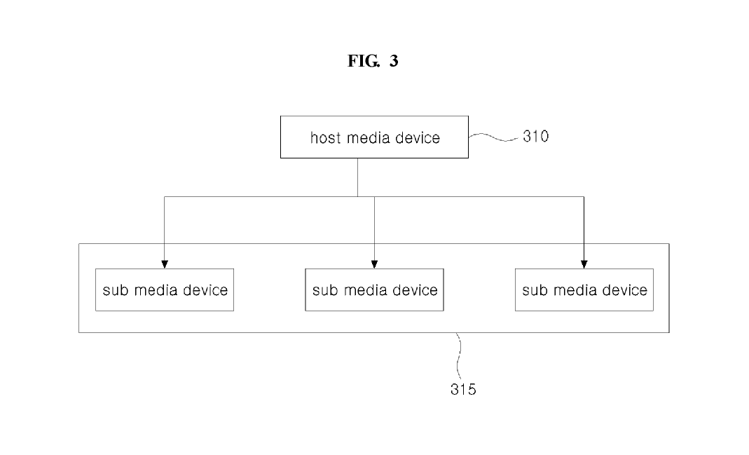

FIG. 3 is a view illustrating a method for setting configuration of a media device in a multi-room environment according to a second embodiment of the invention.

In a multi-room environment in FIG. 3, it is assumed that a host media device 310 locates at a center and sub media devices 315 locate in separate rooms, respectively.

The host media device 310 may transmit essential setting information to be commonly applied to each of the sub media devices 315. Of course, each of the sub media devices 315 may obtain the essential setting information after accessing the host media device 310.

The sub media device 315 may perform a basic process of setting its configuration by using the essential setting information obtained from the host media device 310.

In the event that each of the sub media devices 315 completes an initial setting of the configuration based on the essential setting information received from the host media device 310 and users respectively locate in separate rooms, each user may change the configuration of the sub media devices 315 depending on setting information received from the user's portable terminal in the separate room.

For example, it is assumed that French person (hereinafter, referred to as “first user”) locates in a first room. In this case, the first user may transmit nation information to a first sub media device through his portable terminal (hereinafter, referred to as “first portable terminal”), and the first sub media device may set the configuration to use the French language. Furthermore, the first user may also transmit a user account (e.g., social media account) to the first sub media device through the first portable terminal.

Accordingly, the first sub media device may separately store/manage the user account received from the first portable terminal of the first user. As a result, in the event that the first user wants to access the social media, he can easily access the social media by using the user account stored/managed in the first sub media device without an inconvenient process of inputting the user account through a remote controller.

It is assumed that a teenager (hereinafter, referred to as “second user”) locates in a second room. A second sub media device located in the second room may obtain setting information from a second portable terminal of the second user.

Accordingly, the second sub media device may change at least a portion of a configuration of the second sub media device by using the setting information obtained from the second portable terminal.

Here, the setting information includes one or more of a user account, main channel information or user information.

The second media device may set programs to be blocked in advance (viewing constraint) or allowable programs according to the user information stored in the setting information. In addition, the second sub media device may automatically set the user account of an application or a social media to be accessed by the second user according to the user account in the setting information, so that a login can be automatically performed to the application or the social media without extra inputs.

In the multi-room environment, the sub media device located in each room may set the initial setting of its configuration depending on the essential setting information received from the host media device, and then change or renew at least a portion of the configuration according to the setting information obtained from corresponding user's portable terminal in each room.

The method for setting the configuration in FIG. 3 may be also applied to a media device located in each room in a youth hostel or a hotel, etc. other than the multi-room environment.

In the multi-room environment, the host media device 310 or each of the sub media devices 315 may register in advance terminal information for allowing access to corresponding media device.

Accordingly, in the event that certain user accesses the sub media device 315 through his portable terminal using a cable or wireless communication, the sub media device 315 located in each of the rooms may cancel the communication connection when terminal information of the portable terminal does not correspond to the terminal information for allowing the access.

Accordingly, the sub media device 315 may obtain setting information from corresponding user's portable terminal only when the user having access authority locates nearby to the sub media device 315, and set, change or renew at least a portion of the configuration of the sub media device 315.

On the other hand, each of the sub media devices 315 may set the configuration according to internal information received from corresponding user's portable terminal without using the initial setting of the host media device 310.

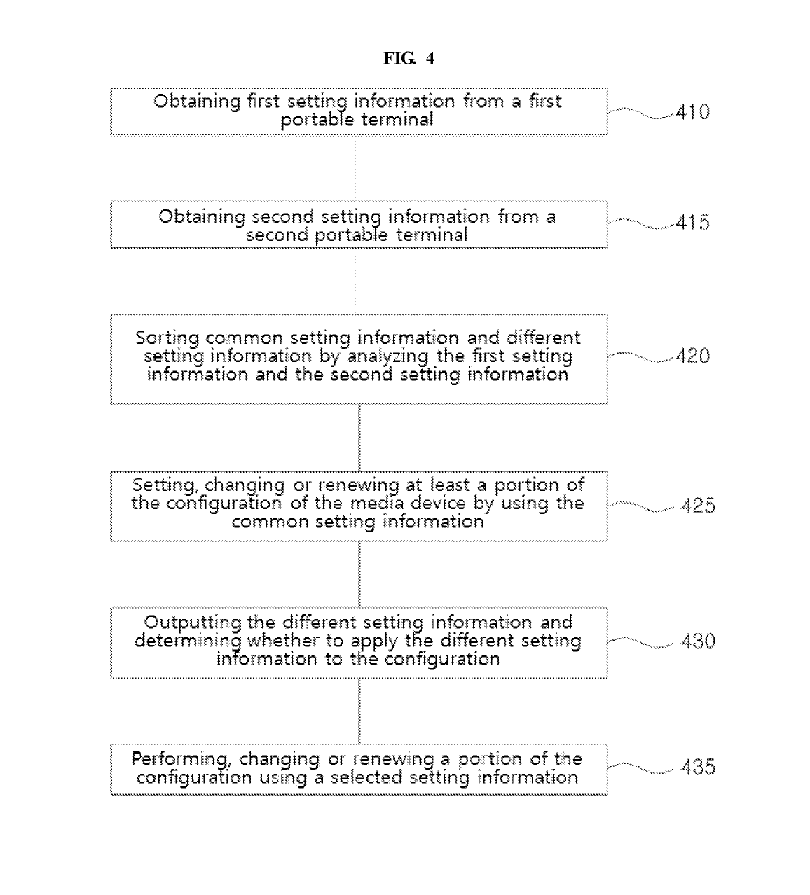

FIG. 4 is a flowchart illustrating a method for setting a configuration of a media device when portable terminals access one media device according to a third embodiment of the invention.

For convenience of description, tt is assumed in FIG. 4 that two users access one media device.

In a step of 410, the media device 120 obtains setting information (hereinafter, referred to as “first setting information”) from a first portable terminal of a first user. As described above, the media device 120 may receive the first setting information through an application installed in the first portable terminal when it is connected to the first portable terminal through the cable or wireless communication such as a Bluetooth pairing.

In a step of 415, the media device 120 obtains setting information (hereinafter, referred to as “second setting information”) from a second portable terminal of a second user.

In a step of 420, the media device 120 sorts common setting information and different setting information by analyzing the first setting information and the second setting information.

In a step of 425, the media device 120 sets, changes or renews at least a portion of the configuration of the media device 120 by using the sorted common setting information of the portable terminals.

In a step of 430, the media device 120 outputs the different setting information item by item and then determines whether to apply the different setting information to the configuration.

In a step of 435, the media device 120 sets, changes or renews a portion of the configuration by using the setting information which is selected among the different setting information to be reflected to the configuration of the media device 120.

Of course, the different setting information can be discarded without using for setting the configuration of the media device 120 according to an embodiment.

For another example, in the event that two or more users correspond to one media device 120, the media device 120 may select any one of portable terminals of the users, obtain basic setting information from the selected portable terminal, and then set, renew or change the configuration of the media device 120 using the obtained basic setting information.

Here, the media device 120 may select one of the portable terminals considering signal intensity of the portable terminals or priority of the portable terminals registered in advance.

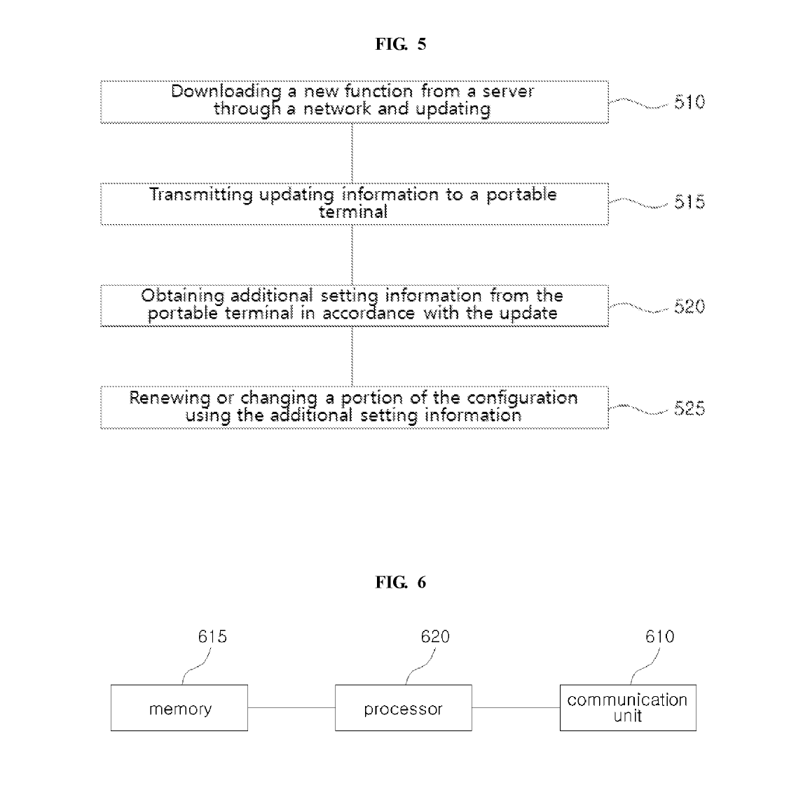

FIG. 5 is a flow chart illustrating a method for renewing the configuration of the media device according to a fourth embodiment of the invention. Hereinafter, a method for renewing a portion of the configuration of the media device 120 through operating with the portable terminal 110 as the media device 120 is updated will be described in detail.

In a step of 510, the media device 120 downloads a new function from a server (not shown) via a network and updates according to the downloaded new function.

In a step of 515, the media device 120 transmits the updating information of the media device 120 to the portable terminal 110.

For example, the media device 120 may transmit the updating information to the portable terminal 110 when it is connected to the portable terminal 110. For another example, in the event that information about the media device 120 is stored through a cloud server, the updating information of the media device 120 may be stored in the cloud server. The updating information of the media device 120 may be delivered to the portable terminal 110 via the cloud server.

Accordingly, the portable terminal 110 may extract additional setting information of the internal information of the portable terminal 110 according to the updating information of the media device 120 and transmit the extracted additional setting information to the media device 120.

In a step of 520, the media device 120 obtains the additional setting information from the portable terminal 110. For example, it is assumed that the updating of the media device 120 corresponds to installation of the social media. In this case, the portable terminal 110 may select a social media account from the internal information of the portable terminal 110 as the additional setting information and transmit the additional setting information to the media device 120.

In a step of 525, the media device 120 renews a portion of its configuration by using the additional setting information obtained through the portable terminal 110.

In FIG. 5, the media device 120 obtains the additional setting information from the portable terminal 110 in accordance with the update when a function of the media device 120 is updated. On the other hand, in the event that internal information or a function of the portable terminal 110 is updated, the portable terminal 110 may transmit additional setting information to the media device 120 according to the updating information.

Since the media device 120 and the portable terminal 110 share the updating information, the internal information pre-stored in the portable terminal 110 may be used as the additional setting information needed for setting the configuration of the media device 120. As a result, user's inconvenience occurred when inputting information via the remote controller may be minimized.

On the other hand, in the event that information about the user (hereinafter, referred to as “user information”) is stored in the cloud server, the media device 120 may receive the user information from the cloud server when a request for the setting of the configuration is received from the portable terminal 110 and set at least a portion of the configuration of the media device 120. Here, information to be set to the configuration of the user information may be predetermined to the media device 120.

FIG. 6 is a block diagram schematically illustrating constitution of a portable terminal according to a first embodiment of the invention.

In FIG. 6, the portable terminal 110 of the present embodiment includes a communication unit 610, a memory 615 and a processor 620.

The communication unit 610 is a means for exchanging data with other devices (e.g., the media device 120) through a cable or wireless communication or a mobile communication.

The memory 615 stores one or more applications.

The processor 620 controls internal elements of the portable terminal 110. Furthermore, the processor 620 may execute an application stored in the memory 615.

The application executed by the processor 620 may extract at least a portion of the internal information of the portable terminal 110 and transmit the extracted internal information as the setting information needed for setting the configuration of the media device 120 to the media device 120.

The application executed by the processor 620 may selectively process information corresponding to a designated item by using at least a portion of the internal information of the portable device 110 because an item needed for setting the configuration of the media device 120 is designated.

Since file format of the portable terminal 110 and the media device 120 may differ, the application executed by the processor may convert in advance the format of the selected information (e.g., the setting information) to be adaptive to the format of the media device 120 and transmit the converted selected information to the media device 120.

Here, the conversion of the format of the setting information may be performed by the media device 120, not the portable terminal 110.

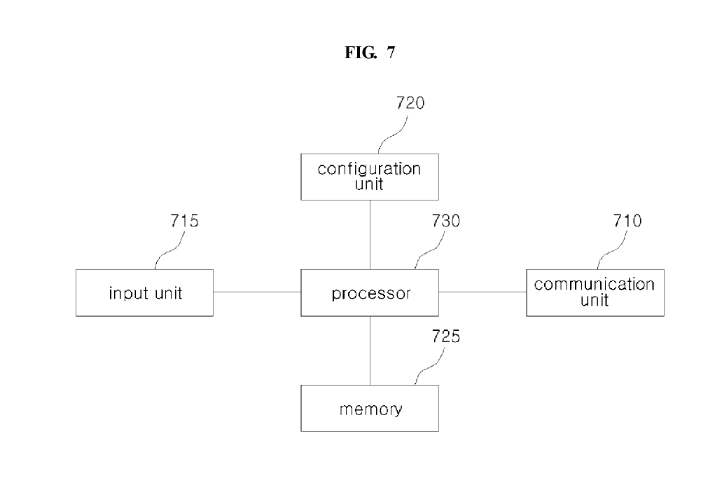

FIG. 7 is a view schematically illustrating constitution of the media device according to a first embodiment of the invention.

In FIG. 7, the media device 120 of the present embodiment includes a communication unit 710, an input unit 715, a configuration unit 720, a memory 725 and a processor 730.

The communication unit 710 is a means for exchanging data with other devices (e.g., the portable terminal 110) through a communication network.

The input unit 715 is a means for receiving an input through the remote controller. For example, the input unit 715 may be an infrared ray port.

The configuration unit 720 sets, changes or renews at least a portion of the configuration by using the setting information obtained through the portable terminal 110 or the additional setting information inputted through the remote controller.

Since the above process is the same as in FIG. 2 to FIG. 5, any further description concerning the same process will be omitted.

The memory 725 stores various applications needed for setting the configuration of the media device 120 and data generated in the setting of the configuration and so on.

The processor 730 controls elements of the media device 120.

The method for the invention described above can be achieved as a computer readable code in a computer readable recording medium. The computer readable recording medium includes every kind of recording mediums for storing data readable by a computer system. For example, the computer readable recording medium may be a read only memory ROM, a random access memory RAM, a magnetic tape, a magnetic disc, a flash memory, an optical data storage device, etc.

The embodiments of the invention described above are disclosed only for illustrative purposes. A person having ordinary skill in the art would be able to make various modifications, alterations, and additions without departing from the spirit and scope of the invention, but it is to be appreciated that such modifications, alterations, and additions are encompassed by the scope of claims set forth below.

As used in the description of the preferred embodiments and the claims, the singular forms “a”, “an” and “the” are intended to include the plural forms as well, unless the context clearly indicates otherwise. It will also understood that the symbol “/” as used herein refers to and encompasses any and all possible combinations of one or more of the associated listed items.

### DESCRIPTION OF REFERENCE NUMBERS

110: portable terminal
120: media device

What is claimed is:

1. A media device comprising:
a communication unit connected to a portable terminal, and configured to receive setting information from the portable terminal, the setting information including at least a portion of internal information of the portable terminal; and
a configuration unit configured to set an initial setting of a configuration by using the received setting information,
wherein the configuration unit sets a user account as one of the initial setting according to the received setting information, and the set user account is matched with personalized information or a personalized service provided for the user after the initial setting is completed.

2. The media device of claim 1, wherein the setting information includes at least one of nation information, local area information, time information, language information or a user account.

3. The media device of claim 1, wherein the setting information is transmitted from the portable terminal to the media device during a process of connecting a channel between the portable terminal and the media device.

4. The media device of claim 1, wherein the configuration unit compares setting information obtained from one or more portable terminals, and sets at least a portion of the initial setting of the configuration of the media device by using common setting information in accordance with the comparing result.

5. The media device of claim 1, wherein the media device corresponds to a sub media device in a multi-room environment,
and wherein the configuration unit sets the initial setting of the configuration according to setting information received from a host media device and changes or renews at least a portion of the configuration by using setting information obtained from a portable terminal in a corresponding room.

6. The media device of claim 1, wherein when setting information of a cloud server is changed according to update of the portable terminal, the configuration unit obtains the changed setting information through synchronization with the cloud server and changes or renews a portion of the configuration by using the changed setting information.

7. The media device of claim 1, wherein when at least a portion of internal information of another portable terminal is obtained as setting information from the another portable terminal as the media device is connected to the another portable terminal after at least a portion of the configuration is set, the configuration unit changes or renews a portion of the configuration of the media device by using the setting information obtained from the another portable terminal.

8. The media device of claim 1, wherein the configuration unit determines the portable terminal related to the initial setting of the configuration as a master terminal and changes the initial setting of the configuration by only control of the master terminal, wherein the initial setting is not changed by information provided from other terminals, not the master terminal.

9. The media device of claim 1, wherein the setting information includes user profile information generated by analyzing user's record in the portable terminal, and the media device sets the initial setting related to at least one of program recommendation, viewing constraint or a login to specific site or program.

10. The media device of claim 1, wherein the media device sets the initial setting of the configuration by using the setting information received from the portable terminal and information received from a device other than the portable terminal.

11. A media device comprising:
a communication unit configured to receive setting information from a plurality of terminals; and
a configuration unit configured to set an initial setting of a configuration by using common information or collection information of the received setting information.

12. The media device of claim 11, wherein the configuration unit sets at least one user account related to users of the terminals by using the setting information when the initial setting is set.

13. The media device of claim 11, wherein the media device or an application of corresponding terminal requests to one of the plurality of terminals for designated information needed for setting the initial setting of the configuration, and the designated information is transmitted from another terminal to the media device when the designated information does not exist in the requested terminal.

14. A user terminal comprising:
a communication unit;
a memory configured to store at least one application and internal information; and
a processor configured to execute the application,
wherein the application executed by the processor obtains internal information to be used for setting the initial setting of a configuration of a media device as setting information, and transmits the obtained setting information to the media device when the user terminal is connected to the media device,
and wherein a portion of the setting information is information related to a setting of a user account of the media device.

15. A method for setting a configuration of a media device, the method comprising:
obtaining setting information to be used for setting the configuration of the media device of internal information of a portable terminal from the portable terminal according as the portable terminal is connected to the media device; and
setting at least a portion of an initial setting of the configuration of the media device using the obtained setting information,
wherein a user account is set as one of the initial setting of the configuration according to the obtained setting information, and the set user account is matched with personalized information or a personalized service provided for the user after the initial setting of the configuration is completed.

16. The method for claim 15, wherein the media device sets the initial setting of the configuration according to common information or collection information of setting information received from a plurality of portable terminals.

17. A set-top box comprising:
a communication unit connected to a portable terminal, and configured to receive setting information from the portable terminal, the setting information including at least a portion of internal information of the portable terminal; and
a configuration unit configured to set an initial setting of a configuration by using the received setting information,
wherein the initial setting includes one or more of a language setting, a nation setting, a time setting or an account setting.
